(19) United States
(12) Patent Application Publication
(10) Pub. No.: US 2014/0324835 A1
(43) Pub. Date: Oct. 30, 2014

(54) Methods And Systems For Information Search

(71) Applicant: The Board Of Regents Of The Nevada System Of Higher Education On Behalf Of The University Of Ne, Las Vegas, NV (US)

(72) Inventor: Martin Roy Schiller, Henderson, NV (US)

(21) Appl. No.: 14/328,316

(22) Filed: Jul. 10, 2014

Related U.S. Application Data
(63) Continuation-in-part of application No. 13/112,746, filed on May 20, 2011.
(60) Provisional application No. 61/395,965, filed on May 20, 2010.

(51) Int. Cl. G06F 17/30

(52) U.S. Cl. CPC G06F 17/30554
USPC 707/722

(57) ABSTRACT

Methods and systems for information search are disclosed. An example method can comprise loading a plurality of content items in a plurality of windows on a display screen, wherein the plurality of the windows can comprise a master window and one or more slave windows, and wherein the each of the one or more slave windows can be associated with a respective search resource. A search request for information associated with a specific word displayed the master window can be received. A search can be conducted via at least one search resource displayed on the one or more slave windows. Search results from the at least one search resource can be provided. The search results can be displayed on a predefined area on the display screen.

### CROSS REFERENCE TO RELATED APPLICATIONS

The present Application claims priority as a Continuation-in-Part Application of U.S. patent application Ser. No. 13/112,746, filed May 20, 2011, which in turn claims priority from U.S. Provisional Patent Application 61/395,965, filed May 20, 2010.

### BACKGROUND

An issue that often makes reading of sophisticated or complex material difficult is the appearance of unfamiliar words or terms that disrupt the flow and comprehension of the material. It slows down the reading process to access a physical dictionary, go online to a distinct site for definitions, or use an embedded dictionary. It is difficult to search many different sources simultaneously and present the data in a customizable manner that can be digitally mined. It is desirable to develop methods and systems for information search that enable customized access and display of information such as definitions related to specific words to minimize interruption of the reading process.

### SUMMARY

It is to be understood that both the following general description and the following detailed description are exemplary and explanatory only and are not restrictive, as claimed. Provided are methods and systems for information search. An example method can comprise loading a plurality of content items in a plurality of windows on a display screen, wherein the plurality of windows can comprise a master window and one or more slave windows, and wherein one or more slave windows can be associated with a respective search resource. A search request for information associated with a specific word displayed in the master window can be received. A search can be conducted at least one search resource displayed on the one or more slave windows. Search results from the at least one search resource can be provided. The search results can be displayed on a predefined area on the display screen.

An exemplary system can comprise a display screen configured for displaying a plurality of content items in a plurality of windows of a display screen, wherein the plurality of windows can comprise a master window and one or more slave windows, and wherein one or more slave windows can be associated with a respective search resource. The system can comprise an input device communicatively coupled to the display device. The input device can be configured for receiving a search request for information associated with a specific word displayed on the master window of the display screen. In an aspect, the system can comprise a processor communicatively coupled to the display screen and the input device. The processor can be configured for loading the plurality of content items in the plurality of windows on the display screen. The processor can be further configured for conducting a search via at least one search resource and providing search results from the at least one search resource. The search results can be displayed on a predefined area on the display screen.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 an illustration of an exemplary display screen;

FIG. 2 is a block diagram illustrating various aspects of an exemplary system;

FIG. 3 is a flowchart illustrating an example method;

FIG. 4 is a flowchart illustrating an example method; and

FIG. 5 is a block diagram illustrating an example computing device.

### DETAILED DESCRIPTION

Before the present methods and systems are disclosed and described, it is to be understood that the methods and systems are not limited to specific methods, specific components, or to particular configurations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in he computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Methods and systems for information search are disclosed. An example method can comprise loading a plurality of content items in a plurality of windows on a display screen, wherein the plurality of windows can comprise a master window and one or more slave windows, and wherein each of the one or more slave windows can be associated with a respective search resource. A search request for information associated with a specific word, phrase, and/or sentence displayed in the master window can be received. In an aspect, the search request can be in form of text, Braille entry, audio command, image search, and the like. A search can be conducted via at least one search resource displayed on the one or more slave windows. Search results from the at least one search resource can be provided. The search results can be displayed on a predefined area on the display screen. In another aspect, if a user does not know a word in the search results, the user can click or hover over the words in the search result, and the definition of the words in the search results can be displayed in a second predefind area on the display screen.

An exemplary system can comprise a display screen configured for displaying a plurality of content items in a plurality of windows, wherein the plurality of windows can comprise a master window and one or more slave windows, and wherein the each of the one or more slave windows can be associated with a respective search resource. The system can comprise an input device communicatively coupled to the display device. The input device can be configured for receiving a search request for information associated with a specific word displayed on the master window of the display screen. The system can comprise a processor communicatively coupled to the display screen and the input device. The processor can be configured for loading the plurality of content items in the plurality of windows on the display screen. The processor can be further configured for conducting a search via at least one search resource and providing search results from the at least one search resource. The search results can be displayed on a predefined area on the display screen.

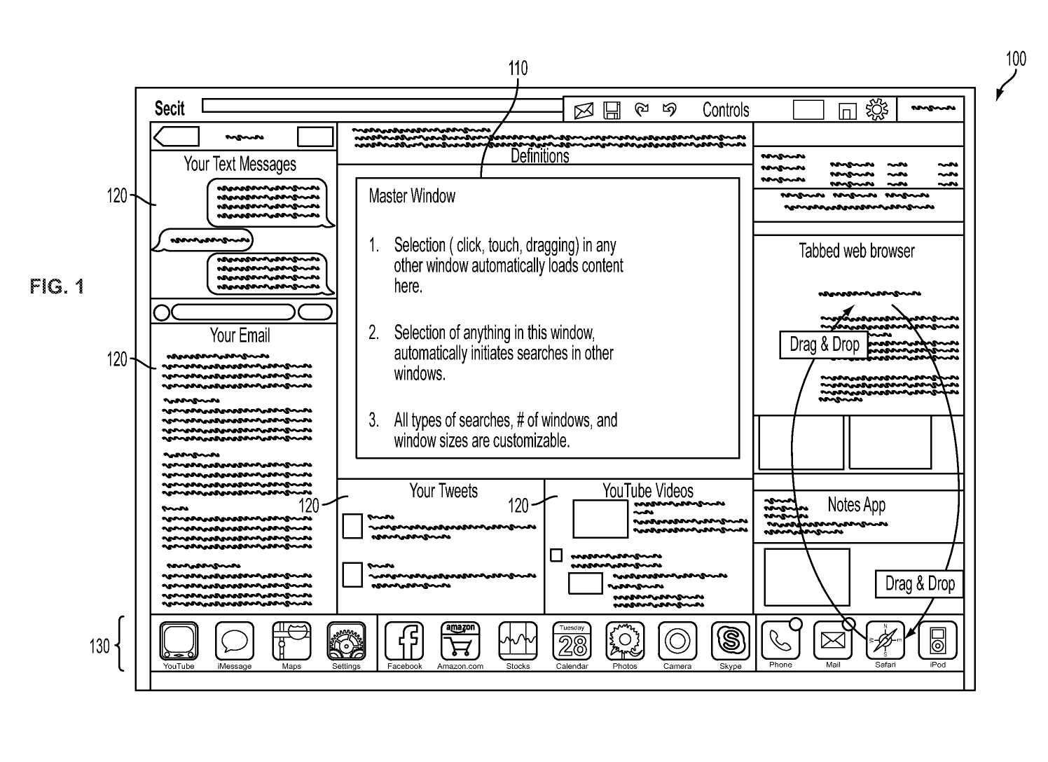

FIG. 1 is an illustration of an exemplary display screen 100 in which the disclosed methods and systems can operate. The display screen 100 can comprise a plurality of windows 110 and 120. In an aspect, the plurality of windows can comprise a master window 110 surrounded by or adjacent to one or more slave windows 120. In an aspect, the master window 110 can be configured for setting display parameters for the plurality of windows. For example, the display parameters can comprise one or more of size, location, font size, color, scrolling options, and the like. In an aspect, a content item (e.g., a document) can be loaded on the master window 110, through which search requests for terms, words, phrases, and the like, can be entered. In another aspect, a plurality of search resources can be loaded on one or more slave windows 120. One or more search resources can be selected via activating the respective one or more slave windows 120. As an example, the slave window 120 can comprise phone message window, one or more e-mail account window, Twitter window, tabbed web browser window, windows for YouTube, FireFox® system, Mozilla® system window, Opera® system window, Bing search screen, Google® search screen, NotesApp® system screen, DropBox® system screen, a file directory on a local or remote computer, and the like. The display screen 100 can be organized according to user preference or according to a pre-set format. As an example, the master window 110 can be located in the center, the upper left corner, the lower right corner, the upper center, of the display screen 100, according to user preference. A user may move the master window 110 to a desired position and execute a lock function to finalize positioning of the master window 110 and any of the slave windows 120 positioned in proximity to the master window 110 on the display screen 100. In an aspect, the user can execute an unlock function and reorganize the plurality of windows (e.g., master window 110, slave windows 120). The display parameters of the plurality of windows and selection of search resources can be saved. As an example, a window (e.g., master window 110, slave window 120) can be dragged to a preferred size and locked, or automatically resized when other windows are removed or added. The configuration of the plurality of windows can be saved. In an aspect, a list of applications can be positioned on the bottom of the display screen 100. One or more applications on the list can be dragged up to create one or more respective slave windows. Similarly, one or more slave windows can be dragged down to put in the list of application on the bottom of the display screen 100.

In an aspect, one or more slave windows 120 can be associated in an organizational distribution that is easily accepted by visual inspection of users and enables ready user access. For example, search engines (e.g., Google, Bing, etc.) can be placed, for example, on the left hand side of the master window 110 or positioned adjacent the upper left and upper right side of the master window 110 so that parallel or consecutive comparison of results can be easily made. As another example, all personal communication links (e.g., E-mail accounts, phone message window, etc.) can be similarly organized so that all personal messages can be viewed on the right side or below the master window 110.

In an aspect, a tool bar 130 can be provided on the display screen 100.

The tool bar 130 can comprise a plurality of icons linking to a respective plurality of search resources (e.g., search engines, communication links). A user can select (e.g., click, drag) an icon on the tool bar 130 and move the selected icon to a slave window 120 as a potential search resource.

In an aspect, the tool bar 130 provided on the display screen 100 can enable a user to select from among the more prominent search engines or communication links, as with a row of icons which may be accessed via the display screen 100. As an example, screen access can mean touchscreen, mouse contact, voice activated, or even rationally activated selection, then positioned about the screen in distinct, layered, overlapped, separated or otherwise user-organized distributions about the display screen prior to execution of a locking function to finally position all window components. Drag and drop movement of the individual engines can be performed, and an expansion or contraction of window component frames for the respective search or communication elements may also be performed before locking. The system may be later unlocked and new user-instigated reorganization initiated.

The disclosed methods can be performed on the Master Window, by entering data into the Master Window, selecting a word already displayed in the master window, or by entering words/terms into the individual search or communication engines and having the processor relay those entries to parallel systems (e.g., among all the search engines or among all the personal communication links). In an aspect, more than one computing devices communicatively coupled to each other can be configured to conduct the same definition search. For example, when a user initiates a search on a first computing device, the search can also he conducted on a second computing device coupled to the first computing device. In an aspect, the search results can be displayed on the first computing device and the second computing device. This feature can be called “crowd searching”.

The disclosed methods and system can be used to find definitions for words in any document a user wants to read and display of the words as part of the document the user is reading, thus eliminating the need to focus attention off of the current display. Instead of opening up a separate window, opening up a web browser, or opening up a physical dictionary, all search results can be displayed to the user with minimal user interaction.

In an aspect, the definition of a word can be obtained with minimal effort. A definition of a phrase can be obtained by clicking on (e.g., a long click, a long press), or hovering over a single word in the phrase. For example, the definition for “Secretary of the Interior can he determined simply by clicking on any of the four words that make up the phrase.

The defined term with definition or a file identifier can be displayed as at least an image or icon of a word in a format of that word in combination with all single preceding words and each single subsequent word combination of the word. This can be done as: 1) a user can select a word for definition within a display screen; 2) a client application can send that word along with a section of text surrounding that word to a web server; and 3) the web server can then retrieve definitions from the system database for the selected word, as well as any recognized word phrases containing that word found within the selection of text sent from the client application. This selection of text may, for example, be a sentence to which that the selected word belongs.

The file identifier can comprise an image and/or icon of a word in a format of that specific word in combination with all single preceding word and each single subsequent word combinations of that specific word and a description of the specific database from which the further information is being provided. The defined field of technology can be selected from scientific domains, such as biology, chemistry, physics, and medicine, but may be any scientific or engineering field.

Search results may be displayed on the screen or printed out. During review of a particular text, past reviewed definitions may be stored in a short-list pull-up file. A database may also be constructed by accessing or federating multiple established dictionaries and federating them into one source dictionary as a database. The database, for example, may be federated from one or multiple established dictionaries by parsing individual dictionaries originally in different formats and converting the different formats into a single format for the database. Alternatively, the database can be federated from one or multiple established dictionaries by parsing individual dictionaries originally in different formats and a parsing program is provided to search each dictionary in its native format and then providing the word and associated information to the database. A reader can view the text in one portion of the display screen and the processor can provide multiple definition data structures, which can be information passed from the web server to a client application (sometimes referred to herein as files or file identifiers) of the available definitions for the specific word at the same time in a defined area of the display screen that does not entirely hide any or all of the displayed text.

A “definition data structure” can comprise data content of a definition provided from the web server to a user. Alternatively, the reader can view text in one portion of the display screen and the processor can provide multiple file identifiers of the available definitions for the specific word at the same time in a predefined area of the display screen that does not entirely hide and or all of the displayed text. The predefined area may be a dedicated portion of the display screen along either the top edge of the display screen or along the bottom edge of the display screen, or the defined area can be a dedicated portion of the display screen along either a left edge of the display screen or along a right edge of the display screen. One additional aspect of the present technology is the ability to provide a neural network, or other algorithm on the system to rank definitions or sources according to defined criteria The defined criteria can comprise a) most recent publication, b) an order of respected authority according to a predetermined list, such as 1) JAMA, 2) NEJM, 3) Nature, 4) Random House Dictionary . . . 20) Wikipedia, and the like, c) named authors, and the like. The neural network or other algorithm can also rank definitions according to context (e.g., term is in Title, term is in Abstract, term is in bibliography, etc.).

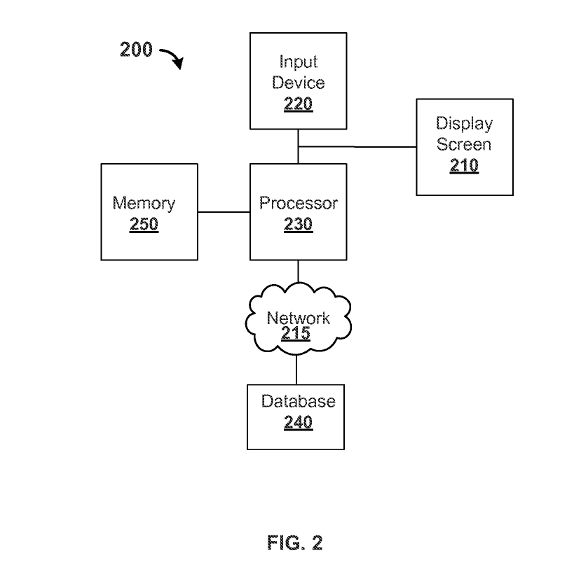

FIG. 2 is a block diagram illustrating various aspects of an exemplary system 200. The system 200 can comprise a display screen 210 configured for displaying a plurality of content items in a plurality of windows. As an example, the display screen 210 can comprise a television, a computer, a PDA, a smartphone, a tablet, and/or the like. In an aspect, a content item can comprise one or more of video content, audio content, image, text, web page, communication link, database, search engine, and/or the like. In an aspect, the plurality of windows can comprise a master window surrounded by or adjacent to one or more slave windows. A content item (e.g., a text document) can be loaded on the master window, through which search requests for terms, words and phrases, and the like, can be entered. A plurality of search resources can be loaded on one or more slave windows.

The system 200 can comprise an input device 220 communicatively coupled to the display screen 210. As an example, the input device 220 can comprise, but is not limited to, a pointing device such as a mouse, trackball, stylus, touch pad, keyboard, microphone, joystick, game pad, satellite dish, scanner, TV tuner card, digital camera, digital video camera, web camera, touchscreens, and the like. The input device 220 can be configured for receiving a search request from a user for information associated with a specific word displayed on the display screen 210. In an aspect, the specific word can comprise a single word, a term, a phrase, a segment of a sentence, and the like. As an example, a search request can be activated by a user command via the input device 220. Examples of user commands via the input device 220 can comprise multi-touch gestures, mouse clicks, voice commands, retinal responses, screen access means, and the like. The type of command utilized will be appropriate for the input device in use. For example, a multi-touch gesture can be used for a smartphone, tablet or a multi-touch trackpad can he used on a desktop computer.

The system 200 can comprise a processor 230 communicatively coupled to the display screen 210 and the input device 220. The processor 230 can be configured for loading a plurality of content items in the plurality of windows on the display screen 210 upon request by a user. The processor 230 can be further configured for conducting a search via at least one search resource associated with the one or more slave windows displayed on the display screen 210 and providing search results from the at least one search resource. The search results can be displayed on a predefined area on the display screen 210. For example, the processor 230 can conduct a search in two or more search resources (e.g., Google, Yahoo, DuckDuckGo) simultaneously. The at least one search resource used can be defined by a user (e.g., reader) and/or by the processor 230. For example, a user can select a search resource, and one or more other search resources can he automatically selected based on appropriate relevance. For example, requesting a search on e-mails correspondence on a specific word can automatically initiate a search on other personal communication networks (e.g., Twitter, phone text, FaceBook, etc.), but would not necessarily initiate a search on Bing. Similarly, a search request on Bing would engage a window search function of Google or YouTube.

In an aspect, the processor 230 can be connected to one or more databases 240 via a network 215 when the search is conducted. In an aspect, the database 240 can comprise a plurality of databases and each of the plurality of databases can be related to defined field of technology or literature, such as biology, chemistry, physics and medicine, and the like. When the search request indicates a defined filed of technology or literature, a respective database can be used.

In one aspect, the network 215 can comprise a packet switched network (e.g., internet protocol based network), a non-packet switched network (e.g., quadrature amplitude modulation based network), and/or the like. The network 306 can comprise network adapters, switches, routers, modems, and the like connected through wireless links (e.g., radio frequency, satellite) and/or physical links (e.g., fiber optic cable, coaxial cable, Ethernet cable, or a combination thereof). In one aspect, the network 306 can be configured to provide communication from telephone, cellular, modem, and/or other electronic devices to and throughout the system 300.

In an aspect, the processor 230 can be connected to a memory 250, as shown in FIG. 2. The memory 250 can comprise various machine-readable media, for example, in providing instructions to processor 230 for execution. As another example, the memory 250 can comprise storage device to store content items (e.g., text documents, e-mail accounts, etc.) loaded on the display screen 210. In another aspect, the database 240 can be stored in the memory 250. The memory 250 may take many forms, including but not limited to, non-volatile media Non-volatile media can include, for example, optical or magnetic disks. Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave, or any other medium from which the processor 230 can read.

In an aspect, a user (e.g., a person) who is reading a document and accessing the present technology, can access a text in memory 250 and display at least a portion of the text on a display screen 210. The user can identify a specific word in the text for which further information is sought.

The user can communicate to the processor 230 that further information is sought on that specific word. The processor can access a database (e.g., internal or external to the system, single sources or multiple sources) having information relating to the defined field of technology or literature. The database can respond by providing content from within the database containing that specific word. Content can be provided containing uses of that specific word in a format of that specific word in combination with all single preceding word and each single subsequent word combinations of that specific word, and the provided content can be returned in a format that is recognizable by the reader. In an aspect, the database can create a data structure in memory containing a list of words and their associated definitions. For example, each word can be paired with its definitions and multiple word phrases can be returned. To facilitate user ability to select desired content, the processor 230 can access content based on user preferences. For example, when any search is begun, a patchwork (which may be in any user organized or customized distribution) can be displayed on the screen, such as two or more (e.g., 6 or more) active (by touchscreen mouse, retinal response or voice) windows on the screen, such as a phone text available screen, one or more e-mail account screens, Twitter screen, tabbed web browser, YouTube window, Chrome, FireFox, Mozilla, Opera, Bing search screen, Google search screen, NotesApp screen, DropBox screen and the like. The distinct window functions can be related through the main processor, such that selection of any search activity in one window, automatically (by response and control of the processor) initiates a similar search in all or selected appropriate windows. In an aspect, search resources can be categorized. For example, search resources such as Bing and Google can be categorized as search engines, search resources such as Twitter, FaceBook, e-mails can be categorized as communication links. A request to search on one search resource of a category can initiate a search on other resources in the category, but may not initiate a search in another category. For example, requesting a search on your e-mails for correspondence on a certain topic might automatically require a search on other personal communication networks (Twitter, phone text, FaceBook, etc.), but would not necessarily initiate a search on Bing, which could be an inappropriate waste of memory and logic. Similarly, a search on Bing would engage the window search function of Google or YouTube, but activation of the phone text window in that search is likely to be superfluous and would not be automatically engaged, but would be excluded.

In another aspect, a customized search access screen can be formatted on a display screen associated with a processor with on-line functionality, the screen of the display screen 210 can have at least two distinct search windows displayed and accessed by the processor 230. A user can put a document into the memory 250 and the display screen 210 can display a portion of that document to the user on the screen. A user can identify a specific word in the text displayed by the display screen 210 that he wants via, for example, clicking, hovering, and the like. A client application can communicate with a web server that further information is requested about a specific word and automatically engages at least two distinct search engines. The web server can communicate through at least two distinct search engines with a system database (e.g., internal or external to the system and in either a single or multiple source) to retrieve information relating to the requested word. The database can return information related to the word requested to each of the at least two distinct search engines. The server can return the requested information back to the client application in a format that the client application can display.

In an aspect, the present technology can be used to provide definition information to a reader during reading of a text within a defined field of technology or literature. The defined field may be general such as English language or Science, or may be more specific, such as cellular biology, AIDS, Postural Orthostatic Tachycardia Syndrome, and the like.

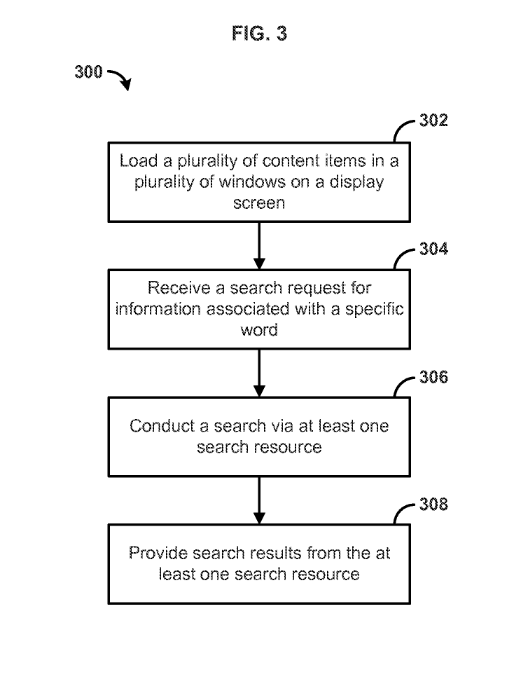

FIG. 3 is a flowchart illustrating an example method. At step 302, a plurality of content items can be loaded in a plurality of windows of a display screen (e.g., display screen 100). In an aspect, one of the plurality of windows can be a configured as a master window (e.g., master window 110). The master window can be configured for setting display parameters for the plurality of windows (e.g., master window 110, one or more slave windows 120). As an example, the display parameter can comprise one or more of size, location, font size, color, scrolling options, and the like. The display screen can be organized according to the aesthetics of a user or according to a pre-set format. As an example, the master window 110 can be located in the center, the upper, left corner, the lower, right corner, the upper center, of the display screen 100, according to user preference. The user can move the master window 110 to a desired position and execute a lock function to finalize positioning of the master window 110 and any of the slave windows 120 positioned in proximity to the master window 110 on the display screen. In an aspect, the master window 110 and one or more slave windows 120 can be positioned in one or more of distinct, layered, overlapped, separated or otherwise user-organized distributions on the display screen 100 prior to execution of a locking function to position of the plurality of windows master window 110, slave window 120).

In an aspect, the master window 110 can be a command window, through which search requests for terms, words, phrases, and the like, can be entered or selected from displayed text. As an example, the one or more slave windows 120 can comprise a phone text window, one or more e-mail account windows, a Twitter window, a tabbed web browser window, a windows for YouTube, FireFox® system, Mozilla®, Opera®, Bing search window, Google® search window, NotesApp® window, DropBox® window, and the like. In an aspect, the one or more slave windows can be associated with respective one or more search resources. Content displayed at one or more slave windows 120 can be moved to master window 110 to become a source of search items. As an example, a search resource can comprise a search engine (e.g., Google®, Yahoo®, Youtube®), a communication link (e.g., e-mail account, facebook account, etc.), a database (e.g., definition database, online dictionary), and/or the like. In an aspect, a database can comprise an internal database, an external database, or a combination thereof.

At step 304, a search request for information associated with a specific word can be received. As an example, the specific word can comprise a single word, a phrase, a term, a segment of a sentence, a sentence, and/or the like. In an aspect, a user can load a document on the master window 110. In another aspect, the content displayed on one or more slave windows 120 can be loaded to the master window 110. The user can read the document while activate a search request for information (e.g., definition) on a specific word in the document. Examples of user commands can comprise multi-touch gestures, mouse clicks, voice command, retinal response, screen access means, and the like. The type of command utilized will be appropriate for the device in use. For example, a multi-touch gesture can be used for a smartphone, tablet or a multi-touch trackpad can be used on a desktop computer. In an aspect, the search request can indicate one or more predefined fields, such as biology, chemistry, physics, engineering, medicine, art, psychology, social science, and the like. In another aspect, the search request can indicate one or more predefined internal and/or external databases.

At step 306, a search can be conducted via at least one search resource based on the search request. In an aspect, a user can select one or more search resources (e.g., search engines) by activating (e.g., long clicking, clicking) the respective one or more slave windows. In an aspect, the at least one search resource can be determined by a user, a processor, or a combination thereof. For example, a user can select a search resource, and one or more other search resources can be automatically selected based on appropriate relevance. In an aspect, search resources can be categorized. For example, search resources such as Bing and Google can be categorized as search engines, search resources such as Twitter, FaceBook, e-mails can be categorized as communication links. A request to search on one search resource of a category can initiate a search on other resources in the category, but may not initiate a search in another category. For example, requesting a search on e-mails for correspondence on a specific word can automatically initiate a search on other personal communication networks (e.g., Twitter, phone text, FaceBook, etc.), but would not necessarily initiate a search on a search engine (e.g., Bing). Similarly, a search request on Bing would engage a window search function of Google or YouTube.

In an aspect, the search can be conducted in one or more predefined fields such as biology, chemistry, physics, engineering, medicine, art, psychology, social science, and the like. In another aspect, the search can be conducted in one or more predefined databases. The one or more predefined databases can comprise one or more of an internal database and an external database. As an example, an external database can comprise one or more established dictionaries (e.g., oxford dictionary, Merriam-Webster Online, etc.) accessible via a network (e.g., network 215). As another example, an internal database can be constructed by federating a plurality of established dictionaries into one source dictionary. In an aspect, the system (e.g., process 320) can automatically exclude certain words from a word phrases as insignificant, such as prepositions, definite articles, indefinite articles, pronouns, and the like when a search is conducted. As an example, a search can utilize natural language processing (NLP), text mining, and the like.

At step 308, search results can be provided from the at least one search resource. As an example, the search results can comprise one or more of: a definition of the specific word, a pronunciation of the specific word, a usage of the specific word, a combination of the specific word with a single preceding word, a combination of the specific word with a single subsequent word, and the like. In an aspect, usage of the specific word can comprise a list of e-mail correspondence in which the specific word is used. Other information can be included in the search results. For example, a list of candidate alternative spellings of the specific word can be provided in the search results. As another example, a list of misspellings of the specific word can be provided in the search results. In an aspect, the search results can comprise text, image, audio, video, a combination thereof. In an aspect, the search results can be included in a file with a specific format recognizable by the user (e.g., reader), and the file can be displayed in the predefined area of the display screen. As an example, the search results can be provided to the user, either in a column adjacent the specific word, a box adjacent the specific word, a picture-in-picture format, a balloon over the specific word, or in any other format on the display screen. In an aspect, it is possible to have multiple screens (e.g., a major screen and a minor screen) on a device, so that search results (e.g., definitions) can be provided on the minor screen attached to the device, while the reading material can be provided the major screen. In another aspect, a separate device (e.g., cell phone, iPhone, PDA, Blackberry, etc.) directly (by wire or cable) or indirectly (WiFi, etc.) associate with the user (e.g., reader) can be used to display the search results.

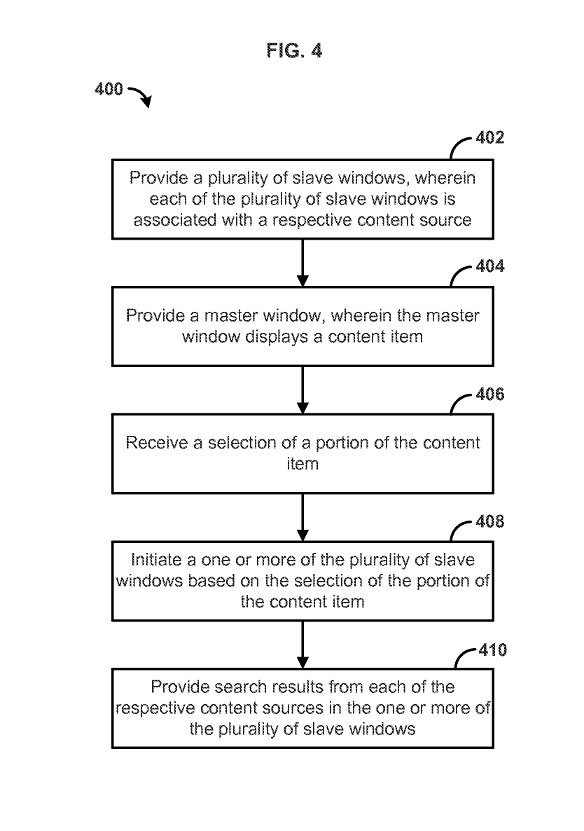

FIG. 4 is a flowchart illustrating an example method. At step 402, a plurality of slave windows can be provided. The plurality of slave windows can be provided on a display screen. As an example, the plurality of slave windows can comprise a phone text window, one or more e-mail account windows, a Twitter window, a tabbed web browser window, a windows for YouTube, FireFox® system, Mozilla®, Opera®, Bing search window, Google® search window, NotesApp® window, DropBox® window, and the like. In an aspect, the plurality of slave windows can be associated respective one or more search resources. As an example, a search resource can comprise a search engine (e.g., Google®, Yahoo®, Youtube®), a communication link (e.g. e-mail account, facebook account, etc.), a database (e.g., definition database, online dictionary), and/or the like. In an aspect, a database can comprise an internal database, an external database, or a combination thereof.

At step 404, a master window can be provided. In an aspect, the master window can display a content item. In an aspect, the master window can be a command window, through which search requests for terms, words, phrases, and the like, can be entered or selected from the displayed content item. In an aspect, one or more of the plurality of slave windows can be moved to the master window to be displayed as the content item.

The display screen can be organized according to the aesthetics of a user or according to a pre-set format. As an example, the master window can be located in the center, the upper left corner, the lower right corner, the upper center, of the display screen, according to user preference. The user can move the master window to a desired position and execute a lock function to finalize positioning of the master window and any of the plurality of slave windows positioned in proximity to the master window on the display screen. In an aspect, the master window and the plurality of slave windows can be positioned in one or more of distinct, layered, overlapped, separated or otherwise user-organized distributions on the display screen prior to execution of a locking function to position of the master window and the plurality of slave window. In an aspect, the master window can be configured for setting display parameters for the master window and one or more of the plurality of slave windows. As an example, the display parameter can comprise one or more of size, location, font size, color, scrolling options, and the like.

At step 406, a selection of a portion of the content item can be received. For example, a user can select a portion of the content item (e.g., a specific word) displayed in the master window via, for example, clicking, hovering, the portion of the content item on the master window. The selection of the portion of the content can be transmitted to a processor to initiate a search.

At step 408, a search in one or more of the plurality of slave windows can be initiated. In an aspect, initiating a search in one or more of the plurality of slave windows can comprise identifying one or more relevant content sources in the plurality of slave windows. In an aspect, the one or more relevant search resource is determined by a user, a processor, or combination thereof. For example, a user can select a search resource, and one or more other search resources can be automatically selected based on appropriate relevance. In an aspect, search resources can be categorized. For example, search resources such as Bing and Google can be categorized as search engines, search resources such as Twitter, FaceBook, e-mails can be categorized as communication links. A request to search on one search resource of a category can initiate a search on other resources in the category, but may not initiate a search in another category. For example, requesting a search on e-mails for correspondence on a specific word can automatically initiate a search on other personal communication networks (e.g., Twitter, phone text, FaceBook, etc.), but would not necessarily initiate a search on a search engine (e.g., Bing). Similarly, a search request on Bing would engage a window search function of Google or YouTube.

In an aspect, the search can be conducted in one or more predefined fields such as biology, chemistry, physics, engineering, medicine, art, psychology, social science, and the like. In another aspect, the search can be conducted in one or more predefined databases. The one or more predefined databases can comprise one or more of an internal database and an external database. As an example, an external database can comprise one or more established dictionaries (e.g., oxford dictionary, Merriam-Webster Online, etc.) accessible via a network (e.g., network 215). As another example, an internal database can be constructed by federating a plurality of established dictionaries into one source dictionary. In an aspect, the system (e.g., process 320) can automatically exclude certain words from a word phrases as insignificant, such as prepositions, definite articles, indefinite articles, pronouns, and the like when a search is conducted. As an example, a search can utilize natural language processing (NLP), text mining, and the like.

At step 410, search results from each of the respective content sources in the one or more of the plurality of slave windows can be provided. As an example, the search results can comprise one or more of: a definition of the specific word, a pronunciation of the specific word, a usage of the specific word, a combination of the specific word with a single preceding word, a combination of the specific word with a single subsequent word, and the like. In an aspect, usage of the specific word can comprise a list of e-mail correspondence in which the specific word is used. Other information can be included in the search results. For example, a list of candidate alternative spellings of the specific word can be provided in the search results. As another example, a list of misspellings of the specific word can be provided in the search results. In an aspect, the search results can comprise text, image, audio, video, a combination thereof In an aspect, the search results can be included in a file with a specific format recognizable by the user (e.g., reader), and the file can be displayed in the predefined area of the display screen and/or one or more of the plurality of slave windows. As an example, the search results can be provided to the user, either in a column adjacent the specific word, a box adjacent the specific word, a picture-in-picture format, a balloon over the specific word, or in any other format on the display screen. In an aspect, it is possible to have multiple screens (e.g., a major screen and a minor screen) on a device, so that search results can be provided on the minor screen attached to the device, while the reading material can be provided the major screen. In another aspect, a separate device (e.g., cell phone, iPhone, PDA, Blackberry, etc.) directly (by wire or cable) or indirectly (WiFi, etc.) associate with the user (e.g., reader) can be used to display the search results.

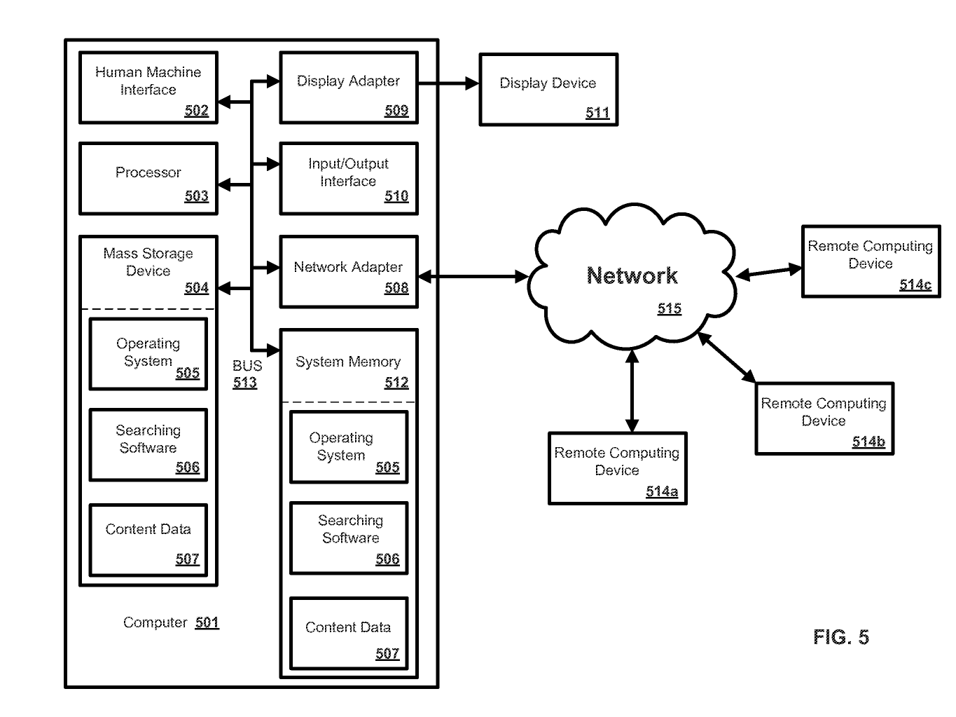

One skilled in the art will appreciate that provided is a functional description and that the respective functions can be performed by software, hardware, or a combination of software and hardware. The methods and systems can be software, hardware, or a combination of software and hardware. The units can comprise the searching Software 506 as illustrated in FIG. 5 and described below. In one exemplary aspect, the units can comprise a computer 501 as illustrated in FIG. 5 and described below.

FIG. 5 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 501. The components of the computer 501 can comprise, but are not limited to, one or more processors or processing units 503, a system memory 512, and a system bus 513 that couples various system components including the processor 503 to the system memory 512. In the case of multiple processing units 503, the system can utilize parallel computing.

The system bus 513 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 513, and all buses specified in this description can also be implemented over a wired or wireless network connection and each of the subsystems, including the processor 503, a mass storage device 504, an operating system 505, searching software 506, content data 507, a network adapter 508, system memory 512, an Input/Output Interface 510, a display adapter 509, a display device 511, and a human machine interface 502, can be contained within one or more remote computing devices 514a,b,c at physically separate locations, connected through buses of this form, in effect implementing a fully distributed system.

The computer 501 typically comprises a variety of computer readable media Exemplary readable media can be any available media that is accessible by the computer 501 and comprises, for example and not meant to be limiting, both volatile and non-volatile media, removable and non-removable media The system memory 512 comprises computer readable media in the form of volatile memory, such as random access memory (RAM), and/or non-volatile memory, such as read only memory (ROM). The system memory 512 typically contains data such as content data 507 and/or program modules such as operating system 505 and searching software 506 that are immediately accessible to and/or are presently operated on by the processing unit 503.

In another aspect, the computer 501 can also comprise other removable/non-removable, volatile/non-volatile computer storage media. By way of example, FIG. 5 illustrates a mass storage device 504 which can provide non-volatile storage of computer code, computer readable instructions, data structures, program modules, and other data for the computer 501. For example and not meant to be limiting, a mass storage device 504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 504, including by way of example, an operating system 505 and searching software 506. Each of the operating system 505 and searching software 506 (or some combination thereof) can comprise elements of the programming and the searching software 506. Content data 507 can also be stored on the mass storage device 504. Content data 507 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 501 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 503 via a human machine interface 502 that is coupled to the system bus 513, but can be connected by other interface and bus structures, such as a parallel port, game port, an IEEE 1394 Port (also known as a Firewire port), a serial port, or a universal serial bus (USB).

In yet another aspect, a display device 511 can also be connected to the system bus 513 via an interface, such as a display adapter 509. It is contemplated that the computer 501 can have more than one display adapter 509 and the computer 501 can have more than one display device 511. For example, a display device can be a monitor, an LCD (Liquid Crystal Display), or a projector. In addition to the display device 511, other output peripheral devices can comprise components such as speakers (not shown) and a printer (not shown), which can be connected to the computer 501 via Input/Output Interface 510. Any step and/or result of the methods can be output in any form to an output device. Such output can be any form of visual representation, including, but not limited to, textual, graphical, animation, audio, tactile, and the like.

The computer 501 can operate in a networked environment using logical connections to one or more remote computing devices 514a,b,c. By way of example, a remote computing device can be a personal computer, portable computer, a server, a router, a network computer, a peer device or other common network node, and so on. Logical connections between the computer 501 and a remote computing device 514a,b,c can be made via a local area network (LAN) and a general wide area network (WAN). Such network connections can be through a network adapter 508. A network adapter 508 can be implemented in both wired and wireless environments. Such networking environments are conventional and commonplace in offices, enterprise-wide computer networks, intranets, and the Internet 515.

For purposes of illustration, application programs and other executable program components such as the operating system 505 are illustrated herein as discrete blocks, although it is recognized that such programs and components reside at various times in different storage components of the computing device 501, and are executed by the data processor(s) of the computer. An implementation of searching software 506 can be stored on or transmitted across some form of computer readable media Any of the disclosed methods can be performed by computer readable instructions embodied on computer readable media Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

in an aspect, the disclosed methods and systems can be referred to as the “SECIT™ system.”

Database

The SECIT™ system dictionary database can comprise at least two main electronic tables. The two electronic tables stored in a memory would contain all of the words in the database along with definitions, part of speech, and other information relevant to retrieval and presentation of the operation of the SECIT™ system. The database is implemented in MySQL.

1.1 Index Table

The first table comprises three columns: A word identification column (“wordID”), a word phrase column (“word”), and a word length column (“length”). The word identification column is made up of a unique number that identifies the word in the same row. The word phrase column is filled with a unique list of every word found in the database. This column is indexed in MySQL due to the fact that unique columns provide efficient searches when indexed. For each word in the word phrase column, there is an entry in the word length column, which is determined by the number of words in the word phrase column. It is important to note that this database delimits words on any character that is not alphabetic. For this reason spaces, hyphens, etc. will count as words in determining the length of a phrase. For example, the row containing the word phrase “Cell membrane” will have a word length value of 3 and the word phrase “used-car dealer” would be 5. To speed up runtime processing time, the length of every word in the index column is preprocessed.

1.2 Definition Table

The second table comprises of a word identification column followed a definition, part of speech (“pos”), source, word phrase, domain, tag count, verb tenses, example, and definition identification column. The word identification column is not unique like it is in the Index Table. This is due to the fact that one word phrase can have many definitions. For example, the word “run” will be given a specific word identification number (3614 in the database). However, since the word “run” has multiple definitions in the definition table, each one of those definitions will be given the same word identification number so that they can be found when the database tries to return the definitions of run. The definition column will contain a specific definition for the word that its word identification number points to. The part of speech column will contain the specific part of speech that this definition refers to. This is required because some words may belong to different parts of speech. For example, the word “run” could be defined as a noun or a verb. The source column contains the dictionary source of the definition. For example, many of English words are pulled from the WordNet 3.0 database, whereas many Biological definitions are pulled from the Medical Subject Headings database. The word phrase column contains the word that is being defined. It is placed in this database for convenience. The length column is a redundant copy of the length column in the index Table. The domain column contains an enumerated value representing the domain of the definition. The domain of a definition can be defined as either the field of study the definition can be found in or what type of word the definition is referring to. For example, a definition of the word “orange” may belong to the domain “fruit” whereas the word laser may belong to the domain “physics.” This column can facilitate in delivering a more accurate definitions or rank order definitions to the user. The tag count column is brought in from the WordNet 3.0 database and it contains information regarding the relevance of a definition. The higher the number in this column is, the more frequently a definition is found to be relevant in writing. The example column will contain, if available, a sample sentence of the defined word used in the context it is being defined in. Finally, the definition identification column contains a unique number identifying each definition. It is not expected to be used, but is included for completeness.

1.3 Database Construction

The database is constructed by taking multiple established dictionaries and federating them into one source dictionary. Due to the fact that almost every external database is constructed with a unique format, a program can be created for each one to import the data into the SECIT™ database. These programs parse the data found in the external database into the format of the SECIT™ database. As time goes on, it is likely that the various external databases would be enhanced or added to. Therefore, the database for SECIT™ would regularly be updated by taking the most up to date external sources and reconstructing the SECIT™ database. There is also a method by which we can generate standardized definitions for gene names, protein names, etc. This is based on using various databases (NCBI Entrez gene, PIR, Gene Ontology, and others to put text into a standard syntax.

2 Front End

The front end of this SECIT™ system application is kept simple but the actual format, design, and functionality is under optimization development and may change in the future to add more features.

2.1 Search Bar

There is a small window at the top of the application that allows a user to input a single word. The word is sent to a server and a list of definitions is returned if the word is found in the database.

2.2 Word Info Area

This area is made up of two major sections, a tab area and a definition area.

2.2.1 Tab Area

Each word that is returned from the server is given a unique tab. If a user clicks on a tab they are given a list of definitions for the word in the definition area below. The last word searched is presented in the active tab and, if identified, a compound word is put in the active tab, rather than the single word that is searched for.

2.2.2 Definition Area

This area contains the definitions of the word given within its tab. The format of a definition is as follows:

[source] part of speech. Definition [“example sentence”]

Different ways of ranking definitions are under development and there are commercially available ranking or hierarchal systems available that can be used in this format. Also, it is worthy of note that clicking on a word in this area will initiate a search on whatever word was clicked. This area will also contain hyperlinks to external information (e.g., a Wikipedia page) when implemented.

2.3 Reading Area

This area contains the uploaded reading material. Currently this is displayed as either plain text or a simple HTML markup. If a user clicks on a word within the reading area, they will be given the definition of that word (and associated word phrases) in the Word Info Area. This display area may he variously located on the screen display.

2.1 Text Input Area

This area allows the user to upload material into the reading area. Currently, the only supported formats are plain text and simple HTML. However, in the future, users can upload PDF files, Office files, etc.

3 Word Search

When a user clicks on a word from either the Reading Area or Word Info Area or enters a word into the search bar, a word search is initiated.

3.1 Reading Area/Word Info Area Search

A word search is carried out in the following manner when initiated from the Reading Area or Word Info Area:

1. The selected word, preferably as well as the entire sentence or a substantive sentence fragment such as at least 4 words, at least 5 words, etc. to which the selected word belongs to) is sent to the server. The word plus the additional content is referred to herein as the “word context.” The word plus at least one of the word and an immediately preceding word and/or an immediately following word are referred to herein as the “word phrase.”

2. The server uses the selected word and/or word context as a well as the words directly to the left and right of the word (i.e., the word phrase) to do a search in the index table. The point of this step is to find all possible word phrases in the database that contain the selected word. To greatly trim the returned set, the words to the left and right of the selected word are used, either one-at-a-time or both at the same time (creating a three-word phrase). For example, if the selected word was “of” the database would return hundreds of phrases containing that word. However, if the word next to “of” in the sentence was “course” the search would return only those containing “of course” which is a much smaller set. Certain words may also be automatically excluded from the word phrases as insignificant, such as prepositions, definite articles, indefinite articles, pronouns and the like.

3. Using the largest length of all returned word phrases, the user's sentence is searched for all of the word phrases returned from step 2. This is necessary because there are almost always many results from step 2 that are not found in the sentence passed through from the user.

4. Any matches that are found from step 3 will have their definitions looked up and are sent back to the user.

5. The user receives a list of word phrases and definitions from the server and creates a tab for each word phrase in the Word Info area Each tab is filled with all corresponding definitions upon creation. The user is then free to read the definition of the selected word as well as word phrases that are both made up of that selected word and contained within the sentence of the selected word.

This process gives the user access to functionality not found in other similar programs. The main advantage to using SECIT™ over other reading environments is the speed and ease of definition searching. By returning both the selected word and related word phrases to the client application, the user does not have to do any additional work to find the definition of a compound word phrase than click on one of its containing words. For example, consider the sentence, “The cell membrane plays host to a large amount of protein that is responsible for its various activities.” (Wikipedia) If the user wants to find the definition of “cell membrane” they can retrieve it by clicking on either “cell” or “membrane.” As a bonus they will receive the word they clicked on in case they would like to see what that word means alone. This feature, as well as the in a frame or fixed-frame definition box style of the Word Info area, reduces the time spent looking up words.

3.2 Single Search

This search is quite simple. The entered word is passed to the server and any definitions are passed back. It does not look for word phrases, but will return a compound word definition if it exists in the data base, as by typing in “cell base” to get the proper complete term definition.

4 Use Cases

The way a user actually uses this application is exemplified above in a non-limiting manner. The following is a walkthrough of a how someone would use the SECIT™ system application:

Joe Smith wants to read an article he found on a topic in Biology. He unfortunately does not know a whole lot about Biology so he knows he will need to look up a lot of the words in the article. He decides to pull up the SECIT™ system to make it a little easier. When the application loads s/he logs in the user name and begins. He copies the text from the article into the Text Input Area and clicks “Input Text.” The Reading Area is then populated with the text from the article. S/He begins reading and doesn't understand one of the words. It is a 3-word phrase so he just clicks on one of the words. The word he clicked on comes up into the Word Info area as well as the 3-word phrase. S/He wanted to know what the 3-word phrase was so s/he reads it since it was selected. S/He now knows what that phrase meant and continues reading. He pulls up a few more definitions and comes across that phrase from before. He just clicks it again and the tab switches back to the same definition phrase and s/he gets a quick refresher. As she/he is reading a word pops into the user's head. The word isn't in the Reading Area, but s/he would still like to know its meaning so s/he types it into the Search Bar and gets a definition for it. As s/he reads further, s/he does a search on a word. While reading the definition there is a word within the definition that she/he doesn't understand. She/He clicks that word and a new tab shows its definition. After reading that definition, she/he clicks on the previous tab and finishes reading the definition at hand. This process continues until the article is finished.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
loading a plurality of content items in a plurality of windows on a display screen, wherein the plurality of the windows comprises a master window and one or more slave windows, and wherein each of the one or more slave windows is associated with a search resource;
receiving a search request for information associated with a specific word, wherein the specific word is displayed in the master window;
conducting a search via one or more search resource displayed on the one or more slave windows: and
providing search results from the at least one search resource.

2. The method of claim 1, wherein the master window is configured for setting a display parameter for the plurality windows.

3. The method of claim 2, wherein the display parameter comprises one or more of size, location, font size, color, and scrolling options.

4. The method of claim 1, wherein the search resource comprises a search engine.

5. The method of claim 1, wherein conducting a search via at least one search resource displayed on the one or more slave windows comprises conducting a search in one or more predefined fields.

6. The method of claim 1, wherein conducting a search via at least one search resource displayed on the one or more slave windows comprises conducting a search in one or more predefined databases.

7. The method of claim 6, wherein the one or more predefined databases comprise one or more of an internal database and an external database.

8. The method of claim 1, wherein conducting a search via at least one search resource comprises conducting a search via one or more search resources.

9. The method of claim 1, wherein at least one search resource is determined by a user, a processor, or combination thereof.

10. The method of claim 1, wherein the search results comprise text, image, audio, video, a combination thereof.

11. The method of claim 1, wherein the search results comprise one or more of: a definition of the specific word, a pronunciation of the specific word, a usage of the specific word, a combination of the specific word with a single preceding word, a combination of the specific word with a single subsequent word.

12. The method of claim 1, wherein the search results are displayed on one or more slave windows, a predefined area on the display screen, or a combination thereof.

13. A system comprising:
a display screen configured for displaying a plurality of content items in a plurality of windows of the display screen, wherein the plurality of windows comprises a master window and one or more slave windows, and wherein each of the one or more slave windows is associated with a search resource;
an input device, communicatively coupled to the display device, configured for receiving a request for information associated with a specific word displayed on the display screen; and
a processor, communicatively coupled to the display screen and the input device, configured for,
loading the plurality of content items in the plurality of windows on the display screen,
conducting a search via at least one search resource displayed on the one or more slave windows, and
providing search results from the at least one search resource, wherein the search results are displayed on a predefined area on the display screen.

14. A method comprising:
providing a plurality of slave windows, wherein each of the plurality of slave windows is associated with a respective content source;
providing a master window, wherein the master window displays a content item;
receiving a selection of a portion of the content item;
initiating a one or more of the plurality of slave windows based on the selection of the portion of the content item; and
providing search results from each of the respective content sources in the one or more of the plurality of slave windows.

15. The method of claim 14, wherein one or more of the plurality of slave windows can be moved to the master window to be displayed as the content item.

16. The method of claim 14, wherein initiating a search in one or more of the plurality of slave windows comprises identifying one or more relevant content sources in the plurality of slave windows.

17. The system of claim 16, wherein the one or more relevant search resource is determined by a user, a processor, or combination thereof.

18. The system of claim 14, wherein the master window is the configured for setting a display parameter for the plurality windows.

19. The system of claim 18, wherein the display parameter comprises one or more of size, location, font size, color, scrolling options.

20. The system of claim 14, wherein the search results comprise text, image, audio, video, a combination thereof.
